(19) United States
(12) Patent Application Publication
(10) Pub. No.: US 2016/0327080 A1
(43) Pub. Date: Nov. 10, 2016

(54) INSTALLATION BOLT

(71) Applicants: Albert J. Razzaboni, Bedford, MA (US); John R. Savage, Lexington, MA (US)

(72) Inventors: Albert J. Razzaboni, Bedford, MA (US); John R. Savage, Lexington, MA (US)

(21) Appl. No.: 14/826,821

(22) Filed: Aug. 14, 2015

Related U.S. Application Data
(60) Provisional application No. 62/158,143, filed on May 7, 2015.

(51) Int. Cl. F16B 23/00; E02F 3/80; F16B 33/00; E01H 5/06

(52) U.S. Cl. CPC F16B 23/0038; E01H 5/061; E02F 3/80; F16B 33/008

(57) ABSTRACT

An improved installation bolt which can quickly and easily attach a plow blade to the moldboard of a vehicle. The assembly comprises a plow blade, moldboard and metal bolt along with washer and nut. The improved installation bolt is achieved using a bolt which incorporates a hex head nut affixed to the top end of the bolt and a tapered bottom portion of the bolt. The hex head nut protrudes above the plane of the plow blade or above the plane of the moldboard to facilitate removal. The plow blade is firmly attached to the moldboard easily and quickly as the tapered bolt aligns several slots of both components so that the remaining bolts can slide into place.

### FIELD OF THE INVENTION

The present disclosure generally relates to an installation bolt. More specifically, the present disclosure relates to an installation bolt for attaching a plow blade or scoop to the moldboard of a vehicle.

### BACKGROUND

In a typical plowing configuration, a plow blade is connected to a moldboard via installation bolts, and the moldboard is in turn connected to a vehicle. The term “blade” refers to the contoured shovel that moves or lifts snow, dirt, soil or other materials. Blades typically range between three and eleven feet in length. The moldboard refers to the flat metal plate operatively affixed to a vehicle. A plow blade is typically connected to the moldboard of a heavy-duty or utility truck, although moldboards can be used in conjunction with many types of automobiles.

While the blade is on the plow, the blade and installation bolt can become corroded by sand, salt, calcium, magnesium, or exposure to weather. Depending on the environment, corrosion of the installation bolt can normally occur within one to three years. When the installation bolt that connects the blade to the moldboard becomes corroded it requires replacement due to the significant increase in the potential for fatigue failure, excessive stress, or thread stripping. The plow blade may also require replacement. For example, a blade may need to be replaced upon contact with surface irregularities such as manhole, catch basin, water or gas box covers, granite curbing, rocks, cement, asphalt, or tree stumps.

In the typical plowing configuration described above, changing the plow blade on a vehicle can be a difficult and time-consuming process. Corrosion of the plow blade, moldboard, and/or installation bolts can create difficulties with removing the installation bolts in order to remove the blade from the vehicle. In some situations, the installation bolt will rotate freely within the attachment hole of a plow blade, making it impossible to seize or grip the bolt head 102 in order to tighten or loosen it. When disassembling the blade, moldboard, and installation bolts it is always the case that the installation bolt is destroyed in the disassembling process because the blade has to be burned off with a blowtorch. Replacement of installation bolts adds to the cost of replacing or changing out a plow blade. For cities with numerous plows that are used simultaneously on a plowing mission, the cost of bolts, nuts and washers plus the additional manpower for all plows is significant.

Once the blade has been removed from the moldboard, the replacement blade is affixed to the moldboard which is attached to the vehicle. For the longer blades this requires three or more people to hold up the blade and align it as another person inserts installation bolts through their slots. To achieve this, the slots in the blade must be exactly aligned with those of the moldboard. The blunt end of existing installation bolts necessitates perfect alignment of the slots in both components. If they are not perfectly aligned, and the operator tries to physically force the bolt into the slot by, for example, striking the bolt with a hammer, the threads on the bolt can be stripped.

Currently, traditional standard bolts vary in tensile and shear strength. However, traditional standard bolts require changes to the mechanical design where applications increase the frequency of use and replacement.

Thus, there is a need for an improved installation bolt for attaching a plow blade to a moldboard. The present invention meets that need.

### SUMMARY OF THE DISCLOSURE

The present disclosure is directed to an improved installation bolt that obviates many of the deficiencies cited above. Specifically, the present disclosure is directed to an improved installation bolt which facilitates an increased frequency of plow blade replacements or changes, re-use of the installation bolt, and improved ease of use.

The present disclosure is generally directed to an installation bolt created from a monolithic elongated member. Monolithic for the present disclosure means consisting of or constituting a single unit. The member has a first section designed to be introduced into a bolt hole comprising a tapered end and a threaded section to interconnect a nut or similar affixing means that is connected to a smooth second cylindrical section which is connected to a third section that comprises a squared portion that divergently tapers into a round flat head with a non-rounded head, such as a hexagonal head, on top of the round flat head.

The present disclosure is also directed to a method of replacing a plow blade comprising:
(a) removing a plow blade attached with at least one bolt to a snow plow moldboard having at least one bolt hole,
said bolt comprising a monolithic, substantially elongated member having:
   (1) a first section configured to be introduced into said at least one bolt hole, said first section comprising a threaded portion and a tapered unthreaded end portion adapted to assist in aligning said bolt with said at least one bolt hole;
   (2) a second section extending from the first section to a third section, said second section comprising an elongated smooth surface portion that extends from the threaded portion of the first section to said third section; and
   (3) a third section comprising a divergent tapered portion and a head protruding therefrom and adapted to be engaged by a tool to rotate said bolt by imparting frictional force sufficient to remove a nut affixed to the threaded central portion of said bolt;
(b) reattaching the plow blade to the moldboard by aligning and introducing the tapered unthreaded end portion of said first section of said bolt into said at least one bolt hole until the head of said third portion of said bolt engages with a depression in said moldboard, and
(c) tightening a nut on the threaded portion of said first section of said bolt.

### BRIEF DESCRIPTION OF THE DRAWINGS

The foregoing and other advantages of the present disclosure will become apparent upon reading the following detailed description and upon reference to the drawings.

FIG. 1A is a side view of a prior art installation bolt.

FIG. 1B is a top view of a prior art installation bolt.

FIG. 2 is a side view of an improved installation bolt in accordance with some embodiments.

FIG. 3 is a bottom view of an improved installation bolt in accordance with some embodiments.

FIG. 4 is a top view of an improved installation bolt in accordance with some embodiments.

FIG. 5 is a side view of the plow blade bolt hole with a partially inserted improved installation bolt in accordance with some embodiments.

FIG. 6 is an angled top view of the plow blade bolt hole with an improved installation bolt in accordance with some embodiments.

FIG. 7 is a top view of the plow blade bolt holes.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

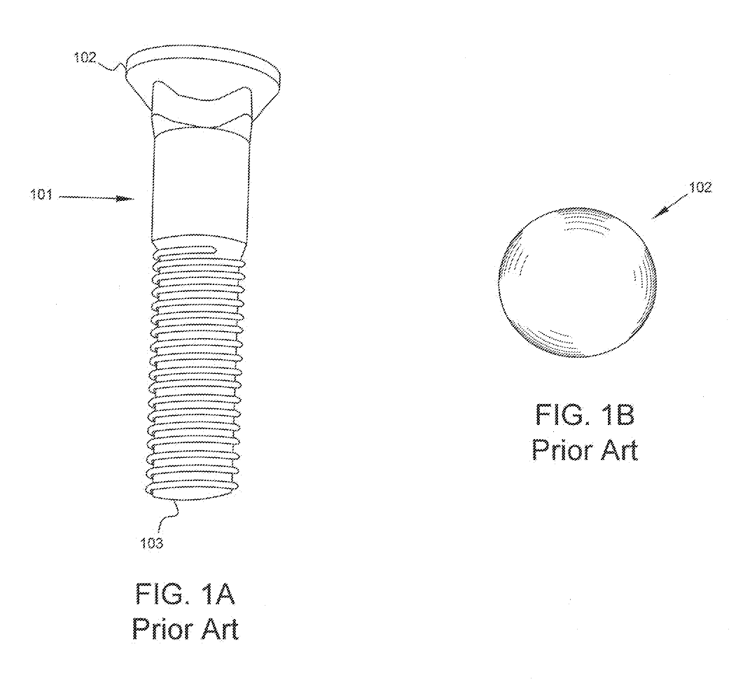

For ease of comparison, FIGS. 1A and 1B provide a known installation bolt 101. The differences there between will be readily apparent to one of skill in the art and are described further below.

As illustrated in FIGS. 1A and 1B, a known installation bolt 101 comprises a monolithic threaded member 103 and a divergent tapered round flat head 102.

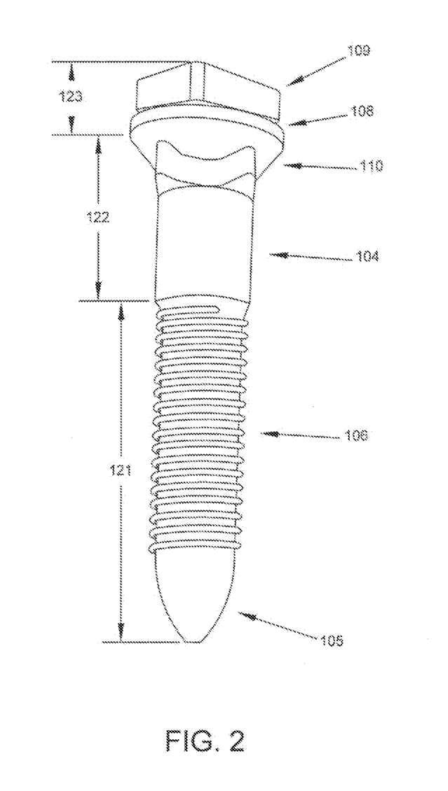

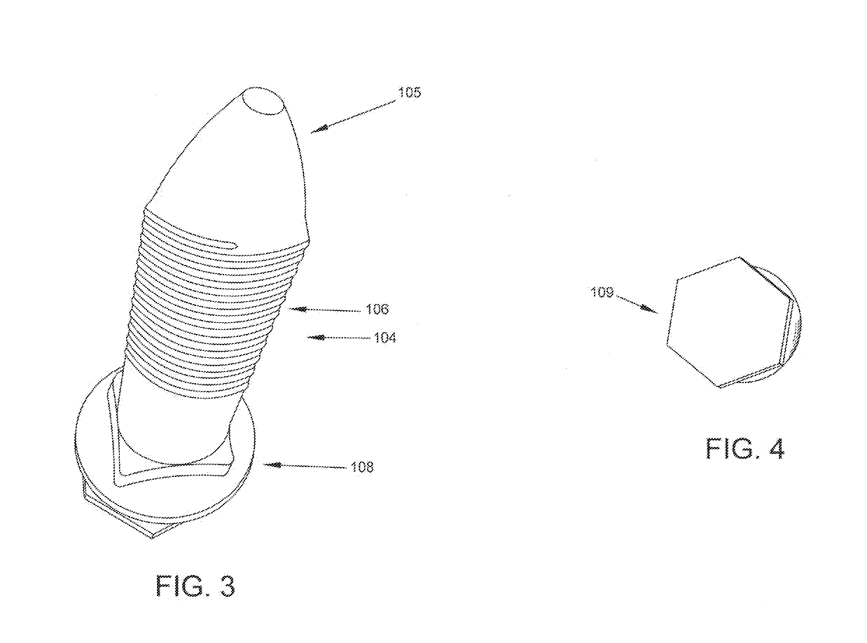

As illustrated in FIGS. 2-6, an improved installation bolt 104 comprises a monolithic, substantially elongated member having three sections: first section 121, second section 122, and third section 123. The first section 121 comprises a tapered end 105 and a threaded portion 106 that is configured to be introduced into a bolt hole of a plow blade and provides a means of affixing the bolt to a nut or similar device. The second section 122 comprises a smooth surface that is diametrically identical to the first section. Second section 122 connects the first section 121 to third section 123. Second section 122 can be made to various lengths, resulting in an alteration of the overall length of improved installation bolt 104. The third section 123 comprises a divergent tapered round flat head 108 having a hexagonal head 109 affixed to the top of the round flat head 108. Hexagonal head 109 is configured to maintain counterforce with a nut or similar device and provide a means of removal or tightening of the improved installation bolt 104.

FIGS. 1A and 1B show a known installation bolt 101 as compared to FIGS. 2-6 which show an improved installation bolt. In some embodiments, the first section 121 comprises tapered end 105 to facilitate bolt alignment. For example, this substantially improves the process of attaching a plow blade to the moldboard for a wide variety of blade bolt hole lengths. Installation bolt 104 is self-aligning due to tapered end 105, which smoothly introduces improved installation bolt 104 to the moldboard and blade, even where bolt holes are not precisely aligned. The improved installation bolt 104 thus requires less time and resources and avoids the usual risk of shearing the bolt threads.

In some embodiments, the second section 122 is configured as a smooth elongated cylinder. The cylindrical design can be used in applications requiring circular bolts. In some embodiments, the second section 122 is an elongated square section. In still further embodiments, the second section 122 is an elongated hexagonal shaped section.

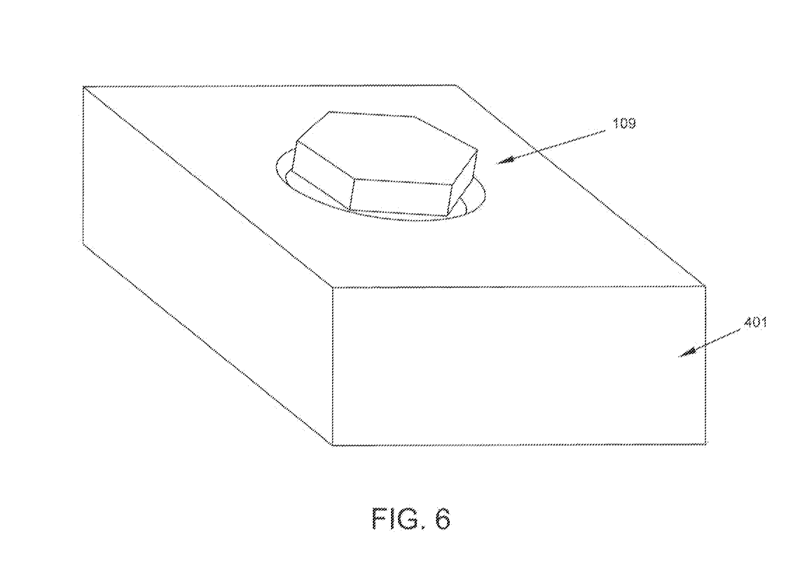

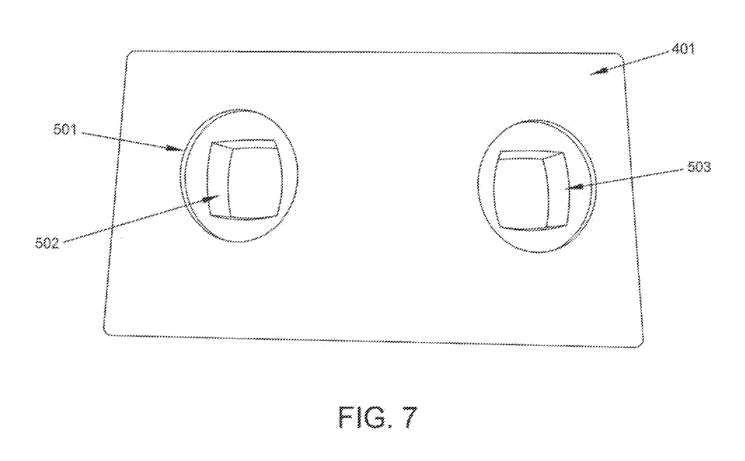

In some embodiments, the third section 123 is formed from a hexagonal shaped head 109 that protrudes above the plane of the blade bolt holes. For example, FIG. 6 illustrates the hexagonal head 109 protruding beyond the plane of blade bolt hole 501. In some embodiments, the hexagonal shaped head 109 is adapted with one or more openings or depressions configured to be engaged by an allen wrench, phillips head screwdriver, or any other tightening or loosening apparatus that can be applied to the openings in the top surface of the improved installation bolt 104. These embodiments simplify removal and tightening of the bolt. In some embodiments, the portion of the third section 123 connected to the second section 122 is square shaped 110. In some embodiments the second section 122 is directly connected to the divergently tapered flat head 108. These designs support various means of securing the improved installation bolt 104 to blade bolt hole 501. The improved design allows for the square shaped section 110 inside the blade bolt hole 502 to become corroded and the bolt to still be an effective securing means. If the blade bolt hole 502 becomes worn down due to corrosion and the opening becomes larger (e.g. at blade bolt hole 503), hexagonal head 109 can be fixed in place by imparting frictional force on the female depression in the moldboard to tighten or loosen the improved installation bolt 104. In some embodiments, the frictional force provided by the moldboard allows for a tool to be used to remove the nut affixed to the threaded portion 106 of the improved installation bolt 104. In some embodiments, a tool can be affixed to impart frictional force on the hexagonal head 109 and a tool can be affixed to a nut on the threaded portion 106 to loosen the nut and remove the bolt in order to replace the snow plow blade.

In some embodiments, improved installation bolt has a diameter of ⅝ inches. In some embodiments, improved installation bolt has a diameter of ½ inches. The improved installation bolts in various embodiments can accommodate any variety of diameter, length, and strength.

In some embodiments the improved installation bolt 104 is comprised of metal or similar alloy necessary for the application. In some embodiments, the installation bolt 104 is coated with a non-rusting substance or material. In other embodiments, the installation bolt 104 comprises a non-metallic material.

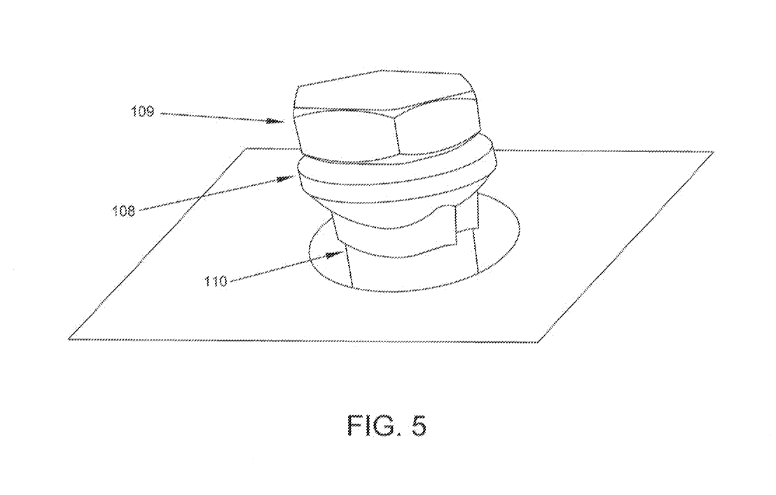

FIGS. 5 and 6 provide an improved installation bolt 104 as shown inserted into the bolt holes of a moldboard 401. As shown in FIGS. 5 and 6 and as discussed above, the head 102 of known installation bolt 101 sits substantially flush with the exterior surface of moldboard 401, while the hexagonal head 109 of improved installation bolt 104 extends beyond the exterior surface of moldboard 401. Since the head 102 of known installation bolt 101 sits substantially flush with the exterior surface of moldboard 401, there is nothing to grab in order to tighten it in place or remove it. Thus, the bolt will spin in a round bolt hole that has been corroded.

The present disclosure includes many advantages over the existing art. Most notably, the improved installation bolt simplifies the process of installing and/or removing the bolt as is done, for example, when changing a plow blade secured by such bolts. The improved installation bolt 104 resolves multiple problems of prior art bolts. First, the bolt saves time during removal of the used blade for attachment of a new blade to a moldboard. Second, if the improved installation bolt becomes corroded, rusted, or worn, it can still be removed because it is always possible to seize the hexagonal head with a socket and ratchet, open-end wrench, allen or phillips head wrench. Concurrently, the tapered design smoothly introduces the installation bolt into blade bolt hole and the moldboard at the slots in which they align. In a typical plowing assembly, the tapered end of an improved installation bolt passes through the bolt hole of a moldboard and into the bolt hole of a plow blade. Once the threads of the first section of the improved installation bolt are engaged in the threaded bolt hole of the plow blade, the bolt holes of the plow blade and moldboard are pulled into alignment. This self-alignment improvement thus obviates the need to perfectly align the bolt holes of the moldboard and plow blade before insertion of the installation bolt. The tapered design therefore requires less time and resources and avoids risks caused by physically jamming the installation bolt into the blade bolt hole. Finally, the design of the installation bolt as disclosed herein renders the installation bolt reusable thereby saving the cost of a full set of new bolts and other components for every re-attachment.

Although discussed above in the context of attaching a plow blade to the moldboard of a vehicle, the present disclosure is not so limited in its application. The improved installation bolt disclosed herein may be suitable for a wide range of applications, not limited to the attachment of additional equipment such as a snow plow, soil grader, scoop to the moldboard of a vehicle.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

What is claimed is:

1. A bolt, comprising:
a monolithic, substantially elongated member having:
a first section configured to be introduced into a bolt hole, said first section comprising a threaded portion and a tapered unthreaded end portion adapted to assist in aligning said bolt with said bolt hole;
a second section extending from the first section to a third section, said second section comprising an elongated smooth surface portion that extends to the threaded portion of the first section; and
said third section comprising a divergent tapered portion and a head protruding therefrom and adapted to be engaged by a tool to rotate said installation bolt.

2. The installation bolt of claim 1, wherein the first section and the second section have the same diameter.

3. The installation bolt of claim 2, wherein the diameter of the first and second section is ⅝ inches.

4. The installation bolt of claim 2, wherein the diameter of the first and second section is ½ inches.

5. The installation bolt of claim 1, wherein the diameter of the first section is less than that of the second section.

6. The installation bolt of claim 4, wherein the first section further comprises a smooth tapered portion between the threaded portion and the second section configured to accommodate a difference in diameter between the first section and the second section.

7. The installation bolt of claim 1, wherein the second section further comprises a substantially square shape section between the elongated smooth surface portion and the third section.

8. The installation bolt of claim 6, wherein the outer periphery of the substantially square shape section sides are concave in.

9. The installation bolt of claim 1, wherein the elongated smooth surface portion in the second section is cylindrically shaped.

10. The installation bolt of claim 1, wherein the elongated smooth portion in the second section has a polygonal shape adapted to impart frictional force on a bolt hole.

11. The installation bolt of claim 1, wherein the hexagonal head further comprises a female depression configured to accommodate a tool adapted to impart rotational force to said installation bolt.

12. The installation bolt of claim 11, wherein the tool adapted to impart rotational force is an allen wrench.

13. The installation bolt of claim 1, wherein the installation bolt further comprises a rust inhibitor coating.

14. The installation bolt of claim 1, wherein the first, second, and third sections are formed from a non-metallic material.

15. The installation bolt of claim 1, where in the installation bolt is adapted to connect to a plow blade of a plow.

16. A apparatus for securing a plow blade to a moldboard, comprising:
a monolithic elongated member having a tapered and unthreaded proximal end, a tapered distal end having a hexagonal head, and a threaded central portion joining said proximal end to said distal end.

17. A method of replacing a plow blade comprising:
(a) removing a plow blade attached with at least one bolt to a snow plow moldboard having at least one bolt hole,
said bolt comprising a monolithic, substantially elongated member having:
(1) a first section configured to be introduced into said at least one bolt hole, said first section comprising a threaded portion and a tapered unthreaded end portion adapted to assist in aligning said bolt with said at least one bolt hole;
(2) a second section extending from the first section to a third section, said second section comprising an elongated smooth surface portion that extends from the threaded portion of the first section to said third section; and
(3) a third section comprising a divergent tapered portion and a head protruding therefrom and adapted to be engaged by a tool to rotate said bolt by imparting frictional force sufficient to remove a nut affixed to the threaded central portion of said bolt;
(b) reattaching the plow blade to the moldboard by aligning and introducing the tapered unthreaded end portion of said first section of said bolt into said at least one bolt hole until the head of said third portion of said bolt engages with a depression in said moldboard, and
(c) tightening a nut on the threaded portion of said first section of said bolt.
